(19) United States
(12) Patent Application Publication
(10) Pub. No.: US 2003/0018588 A1
(43) Pub. Date: Jan. 23, 2003

(54) Method and processing system for using biometric characteristics to monitor machine usage

(76) Inventor: Gustavo M. Guillemin, Jalisco (MX)

Correspondence Address: HEWLETT-PACKARD COMPANY, Intellectual Property Administration, P.O. Box 272400, Fort Collins, CO, 80527-2400, US

(21) Appl. No.: 09/911,647

(22) Filed: Jul. 23, 2001

(51) Int. Cl. G06F 17/60

(52) U.S. Cl. 705/400

(57) ABSTRACT

A method and processing system for using biometric characteristics such as physiological traits to monitor machine usage. In a preferred method, a database of information pertaining to machines to be monitored and biometric characteristics of users of the machines is provided. Mechanisms for determining biometric characteristics of users of the machines during usages of the machines are also provided. A communications mechanism is employed to transmit the biometric characteristics of the users of the machines, and machine usage information associated with the usages of the machines, to a processor which has access to the database of information. The processor is employed to process the biometric characteristics of the users of the machines, the machine usage information, and information from the database to determine amounts to be allocated and/or charged for the usages of the machines.

### BACKGROUND OF THE INVENTION

1. Field of Invention

The present invention relates to a method and processing system for using biometric characteristics such as physiological patterns to monitor machine usage and assign expenses associated with the usage to an appropriate account.

2. Description of the Related Art

Most businesses today, whether large or small, incur expenses that are related to the operation of machines by employees or agents of the businesses. In the case of business machines such as printers, photocopiers and all-in-one (e.g., scanner/printer/copier) products, it is often very difficult or inconvenient to track machine usages to particular employees, projects, etc. This is particularly true where the number of employees of a business is large. Moreover, the current trend toward increased employee mobility makes it even more difficult to track machine usage (e.g., printing/copying) expenses—both inside and outside of office environments.

The lack of a convenient and accurate way to monitor and allocate machine usage expenses can result in a general lack of accountability for the use of machine resources. Moreover, unmonitored machine usage expenses incurred on behalf of a client are often simply categorized as part of the operating “overhead” of the business instead of charged to the client as they should be. This results in fewer reimbursed expenses and thus lower revenues for the business.

Accordingly, it would be helpful to be able to simply and automatically associate machines usages with particular machine users, projects, accounts, etc. It would also be helpful to be able to make these associations without imposing an inconvenient and/or cumbersome machine access routine (e.g., entering passwords on a keypad or the like) on users of the machines while preferably still ensuring that only authorized users of the machines are permitted to use the machines. It would also be helpful if for a single user, it would be possible to associate different machine usages with different accounts, departments or projects depending upon which machine was used, the location of the machine, the amount of usage, the type of usage, the time of usage, whether an authorization was provided for the particular usage, etc.

### SUMMARY OF THE INVENTION

According to the present invention, a method and processing system for monitoring machine usage generally pertain to employing biometric characteristics in combination with a network and database system to track machine usages to particular machine users, determine charges for the tracked usages, and allocate the charges to appropriate accounts, business entities, departments, users, etc.

In accordance with one embodiment of the present invention, a method for using biometric characteristics to monitor machine usage includes the steps of: providing a database of information pertaining to machines to be monitored and biometric characteristics of a group of users of the machines; providing the machines to be monitored with mechanisms for determining biometric characteristics of users of the machines during usages of the machines; employing a communications mechanism to transmit the biometric characteristics of the users of the machines, and machine usage information associated with the usages of the machines, to a processor which has access to the database of information; and employing the processor to process the biometric characteristics of the users of the machines, the machine usage information, and information from the database to determine amounts to be allocated for the usages of the machines. In a preferred embodiment, the database also includes information associating the users of the machines with one or more accounts, and the method also includes the step of: assigning the amounts to the one or more accounts depending upon the biometric characteristics of the users of the machines, the machine usage information, and/or the information from the database.

In accordance with another embodiment of the present invention, a processing system for using biometric characteristics to monitor machine usage includes a processor configured to process machine usage information to determine a machine usage charge and to allocate the machine usage charge depending upon biometric characteristic information associated with the machine usage information. In a preferred embodiment, the processor is configured to allocate the machine usage charge to one or more of a plurality of accounts depending upon a location of a machine that was used, a time that a machine was used, and/or whether a usage of a machine was authorized.

The above described and many other features and attendant advantages of the present invention will become apparent as the invention becomes better understood by reference to the following detailed description when considered in conjunction with the accompanying drawings.

### BRIEF DESCRIPTION OF THE DRAWINGS

Detailed description of preferred embodiments of the invention will be made with reference to the accompanying drawings:

FIG. 1 is a diagram illustrating the flow of information in an exemplary method and processing system for using biometric characteristics to monitor machine usage according to the present invention;

FIG. 2 is a diagram of an exemplary implementation of the method and system of the present invention employing a variety of different mechanisms for determining biometric characteristics of users of a machine; and

FIG. 3 is a flowchart illustrating steps of an exemplary method for using biometric characteristics to monitor machine usage according to the present invention.

### DETAILED DESCRIPTION OF THE PREFERRED EMBODIMENTS

The following is a detailed description of the best presently known mode of carrying out the invention. This description is not to be taken in a limiting sense, but is made merely for the purpose of illustrating the general principles of the invention.

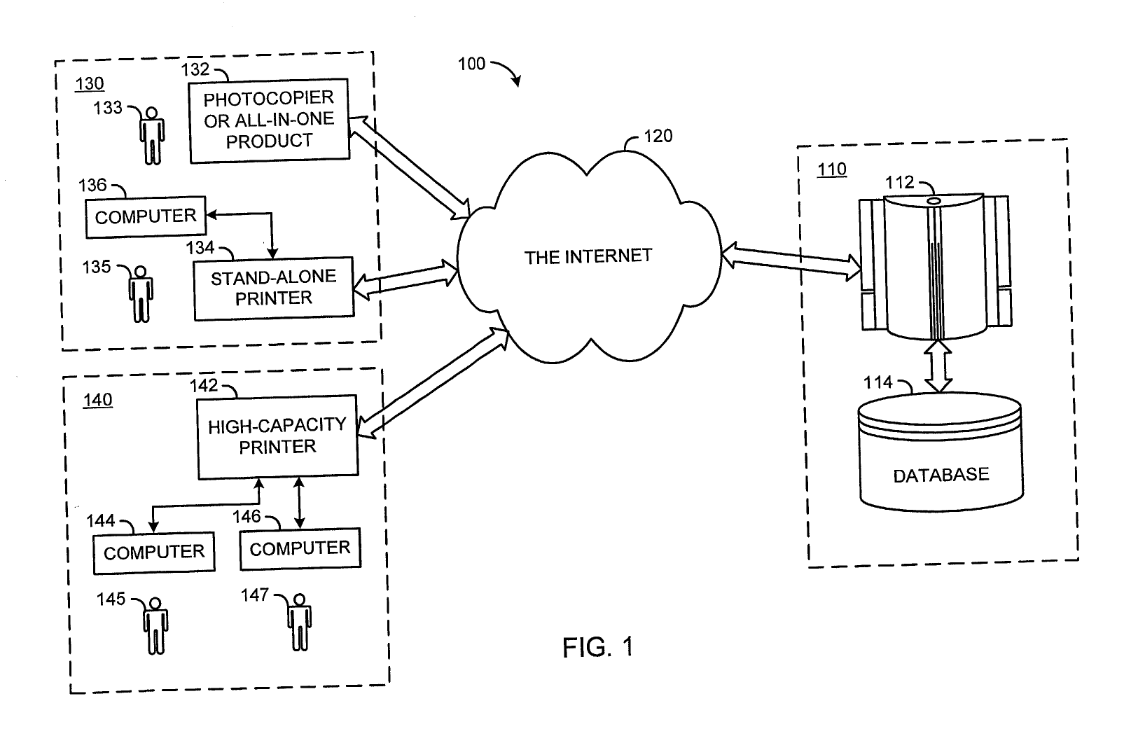

Referring to FIG. 1, a machine usage monitoring and processing system 100 according to the present invention generally includes a processing mechanism 110, one or more machines to be monitored, and a communications mechanism 120. Communications between the processing mechanism 110 and the machines are facilitated by the communications mechanism 120 which can be implemented via any form of communications device or network including but not limited to the Internet, a wide area network (WAN), a local area network (LAN), a network employing wireless communication links (e.g., satellite communication links), a public network, a private network, or a combination of these or other communications devices or networks not explicitly disclosed herein.

The processing mechanism 110 is, for example, a “data processing center” operated by or on behalf of the business or other entity that desires to monitor usage of the aforementioned one or more machines. In the illustrated embodiment, the processing mechanism 110 comprises a processor 112 and a database 114 configured as shown with communications links existing between the processor 112 and the database 114 and between the processor 112 and the communications mechanism 120. The processor 112 may run on any number of different platforms and operating systems including, but not limited to, HP-UX™, Linux™, Unix™, Sun Solaris™ or Windows NT™ operating systems. The database 114 includes stored information which is accessible to and/or generated by operation of the processor 112 as described below. The processing and database components of the data processing center can also be located at separate physical locations. Moreover, the processing component and/or the database component can be distributed as needed or desired depending upon the particular arrangement of machines to be monitored, communications mechanisms available, and other systems considerations.

Referring to the exemplary system of FIG. 1, communications links are provided between the communications mechanism 120 and a plurality of machines 132, 134, 142 which are distributed throughout a plurality of different physical locations 130, 140 as shown. By way of example, machine 132 comprises a photocopier or all-in-one product and machine 134 comprises a stand-alone printer which is communicatively interconnected with and controlled by a computer 136. Machine 142 comprises, for example, a high-capacity printer for a distributed printing system which is configured to process print jobs from computers 144, 146. It should be understood that the principles of the present invention are applicable to any machine and, therefore, are not limited to the machines or machine configurations described herein. Furthermore, any number of machines in any number of different physical locations can be monitored according to the present invention.

A method for using biometric characteristics to monitor machine usage according to one embodiment of the present invention includes the step of transmitting machine usage information and biometric characteristic information of a user of a machine to a processing center which includes a processor configured to process the machine usage information and to allocate a machine usage charge depending upon the biometric characteristic information. According to the present invention, the term “biometric characteristic information” includes physiological traits (such as hand geometry, iris pattern, retinal pattern, wrist vein pattern, facial features and fingerprints) as well as behavioral traits (such as voice pattern recognition, dynamic signature analysis and key-stroke pattern recognition). Preferably, human characteristic information is employed that will uniquely identify an individual such that no two people are exactly the same in terms of the characteristic. It should be appreciated, however, that the scope of the present invention includes the employment of any type of characteristic information to identify users of machines.

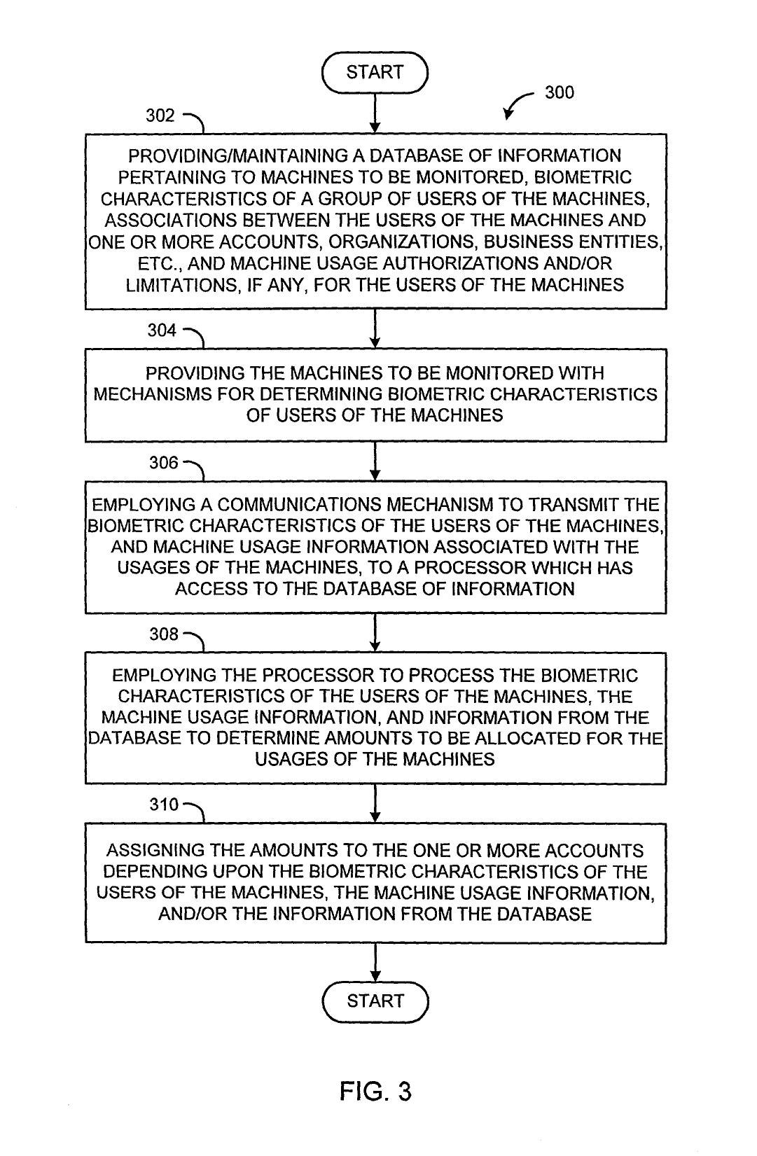

Referring to FIG. 3, an exemplary method 300 for using biometric characteristics to monitor machine usage according to the present invention is shown in the form of a flowchart. At step 302, the information database 114 is provided and/or maintained. In an exemplary preferred embodiment, the database of information pertains to machines to be monitored, biometric characteristics of a group of users of the machines, associations between the users of the machines and one or more accounts, organizations, business entities, etc., and machine usage authorizations and/or limitations, if any, for the users of the machines.

The infonnation pertaining to the machines includes rates to be charged for usage of each machine, for example, rates based on the duration of usage (e.g., time to complete the print job) and/or the volume of usage (e.g., volume of printing stock expended to complete the print job). The rates to be charged for machine usage can vary depending upon a variety of factors. In one embodiment, the actual cost of operating a machine can be used to determine the rate to be charged. For example, the type of machine being operated can be taken into consideration. Accordingly, the actual cost of operating and maintaining a machine over its lifetime can be factored into determining what the rate for using that particular machine should be. The actual cost of operating a machine can also take into consideration (variable) energy costs, expenses associated with employing machine operators, machine insurance costs, and any other quantifiable expense associated with operation of the machine.

In determining the actual cost of operating a machine, the type of usage can also be taken into consideration; for example, a greater rate can be charged per page for 2-sided copying as compared to 1-sided copying. Different rates can also be charged depending upon the nature of the print media being expended. For example, charges for color print media or premium stock can be higher than charges for standard quality or recycled print media. When machine usage involves establishing a telephonic connection, different rates can be charged depending upon whether the call is local or long distance, domestic or international, during business hours or during the evening or on the weekend, etc. Finishing expenses such as stapling or binding can also be charged.

In another embodiment, the rates to be charged for machine usage can depend upon the identify of the person using the machine and/or upon the account, project, department, employer, business or other entity associated with the user of the machine. The rates to be charged for machine usage can also depend upon a location of a machine that was used, a time that a machine was used and/or whether a usage of the machine was authorized. The rates to be charged can also take into consideration a preferred status of particular clients, discounts (e.g., bulk usage discounts), rate adjustments (e.g., rate increases for rush jobs), and other adjusting factors.

As indicated above, information in the database 114 also pertains to the biometric characteristics of a group of users of the machines. By way of example, this information comprises (pre-stored) information pertaining to physiological patterns collected from (authorized) users of the machines. In one embodiment, the physiological patterns are fingerprint patterns. The database of information can additionally or alternatively pertain to other characteristics, patterns or traits of the users of the machines.

At step 304, the machines to be monitored are provided with mechanisms for determining biometric characteristics of users of the machines. Depending upon the specific nature of the biometric characteristics to be acquired and verified, a variety of different commercially-available sensor types can be employed including, but not limited to, optical, capacitive, infrared, ultrasonic and pressure sensors.

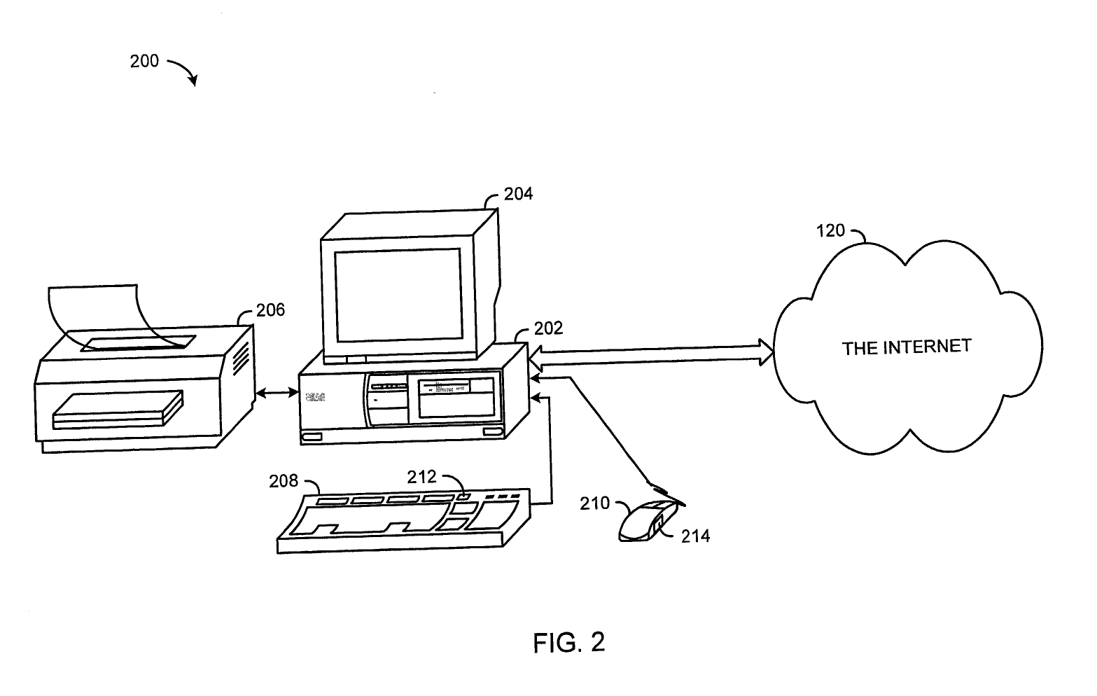

FIG. 2 illustrates a personal computing system 200 configured according to the principles of the present invention. The system 200 includes a personal computer 202 operatively interconnected with a monitor 204, a printer 206, a keyboard 208 and a mouse 210 as shown. The personal computer 202 is configured with an interface card or the like for providing the system 200 with a communications link to the communications mechanism 120 (discussed above). Alternatively, a communications interface can be implemented at the printer 206 for the purpose of establishing a communications link to the communications mechanism 120.

As stated above, the machines to be monitored are provided with mechanisms for determining biometric characteristics of users of the machines. According to the present invention, each machine can be configured with such a mechanism. For example, the copy button of a photocopier is provided with a built-in fingerprint scanner. In another embodiment, the user input peripherals (e.g., keyboard, mouse, etc.) of a computer that provides user inputs to a machine being monitored can be configured with mechanisms for determining biometric characteristics of users of the machine. In the exemplary system 200, a print key of the keyboard 208 is configured with a mechanism for determining biometric characteristics, more specifically, a built-in fingerprint scanner 212. Alternatively (or additionally), the mouse 210 can be configured with a mechanism 214 for determining biometric characteristics.

Referring to FIG. 1, the machine 132 is directly provided with one or more mechanisms for determining a biometric characteristic of the user 133. The computer 136 (that provides user inputs to the machine 134) is provided with one or more mechanisms for determining a biometric characteristic of the user 135. For the “distributed” system which includes the machine 142, the computers 144, 146 are each provided with one or more mechanisms for determining biometric characteristics of the users 145, 147, respectively. In a configuration where a machine can also receive operation commands from a remote location, both the machine and a device at the remote location can be provided with mechanisms for determining biometric characteristics of users of the machine. This facilitates the acquisition of the characteristics for machine users who are providing operating commands at the machine and for machine users who are providing operating commands remotely. Moreover, a plurality of different types of such mechanisms can be employed for determining biometric characteristics of users of any particular machine.

Referring to FIG. 3 (and also FIG. 1), at step 306 the communications mechanism 120 is employed to transmit the biometric characteristics of the users of the machines, and machine usage information associated with the usages of the machines, to the processor 112 which has access to the database 114 of information. At step 308, the processor 112 is employed to process the biometric characteristics of the users of the machines, the machine usage information, and information from the database to determine amounts to be allocated for the usages of the machines. Thus, a method for using biometric characteristics to monitor machine usage according to another embodiment of the present invention includes the steps of: employing a biometric characteristic determining mechanism to acquire a biometric characteristic of a user of a machine during a usage of the machine by the user; and processing information pertaining to the usage of the machine and the biometric characteristic to determine a machine usage charge.

At step 310, the amounts determined in step 308 are assigned to the one or more accounts depending upon the biometric characteristics of the users of the machines, the machine usage information, and/or the information from the database. The one or more accounts can include, for example: a business account associated with at least one of the users of the machines, a personal account (e.g., credit card account) of one of the users of the machines, an account of an organization, business entity, employer or department that the user works for, etc.

The processing system of the present invention can also be configured such that charges associated with a particular user are allocated to different accounts depending upon which machine was used, the location of the machine, the amount of usage, the type of usage, the time of machine usage, whether a project authorization was provided for the particular usage, etc. The processing system can additionally be configured to notify users that they are not authorized to use a particular machine for company business and that any usage will be charged to their personal account.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

I claim:

1. A method for using biometric characteristics to monitor machine usage, comprising the steps of:
providing a database of information pertaining to machines to be monitored and biometric characteristics of a group of users of the machines;
providing the machines to be monitored with mechanisms for determining biometric characteristics of users of the machines during usages of the machines;
employing a communications mechanism to transmit the biometric characteristics of the users of the machines, and machine usage information associated with the usages of the machines, to a processor which has access to the database of information; and
employing the processor to process the biometric characteristics of the users of the machines, the machine usage information, and information from the database to determine amounts to be allocated for the usages of the machines.

2. The method for using biometric characteristics to monitor machine usage of claim 1, wherein:
the database also includes information associating the users of the machines with one or more accounts.

3. The method for using biometric characteristics to monitor machine usage of claim 2, further comprising the step of:
assigning the amounts to the one or more accounts depending upon the biometric characteristics of the users of the machines, the machine usage information, and/or the information from the database.

4. The method for using biometric characteristics to monitor machine usage of claim 2, wherein:
the one or more accounts include a business account associated with at least one of the users of the machines.

5. The method for using biometric characteristics to monitor machine usage of claim 2, wherein:
the one or more accounts include a personal account of one of the users of the machines.

6. The method for using biometric characteristics to monitor machine usage of claim 1, wherein:
the database also includes information pertaining to machine usage authorizations and/or limitations, if any, for the users of the machines.

7. The method for using biometric characteristics to monitor machine usage of claim 1, wherein:
the biometric characteristics include physiological traits.

8. The method for using biometric characteristics to monitor machine usage of claim 7, wherein:
the physiological traits include fingerprints.

9. The method for using biometric characteristics to monitor machine usage of claim 1, wherein:
the biometric characteristics include behavioral traits.

10. The method for using biometric characteristics to monitor machine usage of claim 1, wherein:
the communications mechanism comprises a network.

11. A method for using biometric characteristics to monitor machine usage, comprising the step of:
transmitting machine usage information and biometric characteristic information of a user of a machine to a processing center which includes a processor configured to process the machine usage information and to allocate a machine usage charge depending upon the biometric characteristic information.

12. A method for using biometric characteristics to monitor machine usage, comprising the steps of:
employing a biometric characteristic determining mechanism to acquire a biometric characteristic of a user of a machine during a usage of the machine by the user; and
processing information pertaining to the usage of the machine and the biometric characteristic to determine a machine usage charge.

13. The method for using biometric characteristics to monitor machine usage of claim 12, further comprising the step of:
allocating the machine usage charge to an account associated with the user of the machine.

14. The method for using biometric characteristics to monitor machine usage of claim 12, wherein:
the machine comprises a printer.

15. The method for using biometric characteristics to monitor machine usage of claim 12, wherein:
the machine comprises a photocopier.

16. A processing system for using biometric characteristics to monitor machine usage, comprising:
a processor configured to process machine usage information to determine a machine usage charge and to allocate the machine usage charge depending upon biometric characteristic information associated with the machine usage information.

17. The processing system for using biometric characteristics to monitor machine usage of claim 16, wherein:
the processor is configured to allocate the machine usage charge to one or more of a plurality of accounts depending upon a location of a machine that was used.

18. The processing system for using biometric characteristics to monitor machine usage of claim 16, wherein:
the processor is configured to allocate the machine usage charge to one or more of a plurality of accounts depending upon a time that a machine was used.

19. The processing system for using biometric characteristics to monitor machine usage of claim 16, wherein:
the processor is configured to allocate the machine usage charge to one or more of a plurality of accounts depending upon whether a usage of a machine was authorized.
